(19) United States
(12) Patent Application Publication
(10) Pub. No.: US 2026/0226314 A1
(43) Pub. Date: Aug. 6, 2026

(54) COMPOSITION AND METHOD FOR TREATING THE SURFACE OF GLASS

(71) Applicants: Evonik Operations GmbH, Essen (DE); TotalEnergies OneTech SAS, Solaize Cedex (FR)

(72) Inventors: Philipp ALBERT, Lörrach (DE); Eckhard JUST, Rheinfelden (DE); Jacob SHEVRIN, Port Washington, NY (US); Thomas STRUPPERT, Grossheirath (DE); Dave TOWNSEND, Manasquan, NJ (US); Hans-Joachim BREUER, Niederkassel (DE)

(73) Assignees: Evonik Operations GmbH, Essen (DE); TotalEnergies OneTech SAS, Solaize Cedex (FR)

(21) Appl. No.: 19/118,238

(22) PCT Filed: Oct. 6, 2023
(86) PCT No.: PCT/EP2023/077712

§ 371 Date: Apr. 3, 2025

(30) Foreign Application Priority Data
Oct. 10, 2022 (EP) 22200460.8

(51) Int. Cl. C09D 183/14; C03C 17/30; C09D 7/45; C09D 7/65

(52) U.S. Cl. CPC C09D 183/14; C03C 17/30; C09D 7/45; C09D 7/65; C03C 2217/78

(57) ABSTRACT

The present invention relates to a composition and a method for treating at least one glass surface, preferably the surface of a glass container such as a glass bottle. The present invention further concerns a substrate comprising least one layer obtained by treating at least one glass surface thereof with the composition according to the invention.

The present invention relates to a composition and a method for treating at least one glass surface, preferably the surface of a glass container such as a glass bottle. The present invention further concerns a substrate comprising least one layer obtained by treating at least one glass surface thereof with the composition according to the invention.

### BACKGROUND OF THE INVENTION

Glass derives its strength and optical properties from an unblemished surface, and any surficial damage such as scratches or flaws present on its surface considerably reduce its (basic) strength and in particular its compressive strength. Further, the internal burst strength (also referred to as internal pressure resistance) of glass containers such as bottles may be diminished by surficial damages. This poses a severe risk to anyone using such damaged bottles, especially if they contain carbonated beverages because such bottles might burst. Such scratches and flaws are often caused by normal handling of glass, e.g., of glass bottles containing beverages when used or shipped. Surficial damages of glass-particularly when used for decorative purposes—also are an optical deficit when usually clear and smooth glass surfaces are desired. Examples of products where surficial damages are usually not tolerated by the consumers are mirrors, window glass and decorative glass objects.

To avoid the occurrence of scratches and the loss of strength, glass is often subjected to a surface treatment. This surface treatment protects the glass surface of surficial damages. Commonly, tin salts are applied to the glass surface at a temperature of about 500° C. to form a thin tin oxide layer followed by a layer comprising a gliding agent (also referred to as lubricating agent in the art) such as wax at a significantly lower temperature in order to reduce the frailty of glass surfaces towards defects from handling. The tin oxide is necessary to provide a sufficient adhesion of the gliding agent onto the glass surface. Tin salts often are ecologically problematic and harmful to humans. Organic tin compounds are thus under regulatory pressure and monobutyltin trichloride-one of the most frequent used tin compounds for coating glass bottles-is to be phased out in Europe (CoRAP list ECHA) for this application. However, tin compounds are still used because there is no acceptable alternative available even though various alternatives have been considered without reaching the same protection properties.

Various silanes and siloxanes have been proposed as alternatives to tin salts. These systems use mainly epoxy- and aminofunctional silanes and siloxanes. AU 715826 B2 (application number AU199731796 B2) teaches the use of monoaminosilanes and gliding agents such as polyolefins on glass ware to impart the surface a certain abrasion resistance.

U.S. Pat. No. 6,096,394 B1 discloses the use of organopolysiloxanes in the cold end coating of glass ware.

JP 2004-196563 describes the application of a formulation containing silanes and polymer dispersions. The silanes are mono silyl-silanes or (triethoxysilylproply)tetrasulfid. In the latter case, the odor of the sulfur silane is not acceptable for an application on glass bottles, especially for one containing beverages.

However, still to date, the prior art coatings using silanes or compounds derived therefrom lack scratch resistance (i.e. dry scratch resistance and wet scratch resistance) and in particular wet scratch resistance. Further, many silane-based systems suffer from poor stability of the treatment solutions containing these compounds requiring frequent replacements of such treatment solutions. This is environmentally and economically undesirous. Because of these disadvantages, they have not been introduced into the industry, especially not into large-scale applications.

### OBJECTIVE OF THE INVENTION

It is therefore the objective of the present invention to overcome the shortcomings of the prior art. It is a further objective of the present invention to provide a composition and a method which allows for a sufficiently high scratch resistance of the treated glass surfaces without the use of ecologically harmful tin compounds.

It is of further interest that the optical appearance of glass treated does not become impaired, neither by the treatment itself nor by damages caused by conventional handling. Further, the adherence of labels attached to the treated glass surface has to be acceptable.

### SUMMARY OF THE INVENTION

These objectives are solved by the composition for treating at least one glass surface comprising:
a) at least one bis-silyl compound comprising at least one building block according to formula (A)

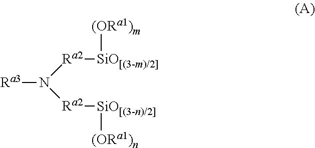

wherein
each R^{a1} is independently selected from the group consisting of hydrogen, alkyl group, polyether group and aryl group,
each R^{a2} is independently an alkanediyl group,
R^{a3} is selected from the group consisting of hydrogen, alkyl group and aryl group,
m is an integer ranging from 0 to 3,
n is an integer ranging from 0 to 3,
and
b) at least one gliding agent selected from the group consisting of wax, fatty acid and fatty acid ester.

Surprisingly, the composition according to the invention is very stable. It can be used and stored for a sufficiently long period of time to be used in the industry. Stability in the context of the present invention is predominantly understood that the composition can be used for the purpose of the invention, i.e. coating of a substrate, particularly a glass surface. It preferably does not show any precipitates or the like. The minimum period of time is 24 h (at 20° C.). Preferably, the period of time is at least 1 week (at 20° C.) or ideally at least 1 month (at 20° C.).

Advantageously, the composition according to the invention is ecologically friendly as no tin compounds are required anymore.

The composition according to the invention advantageously reduces the number of scratches on the at least one glass surfaces and thereby, the loss of (basic) strength and internal pressure resistance can be reduced during use and handling of substrates, especially of hollow containers such as bottles, treated with the composition according to the invention.

Preferred embodiments solving above-described objectives particularly well are described in the following description and in the dependent claims.

### DETAILED DESCRIPTION OF THE INVENTION

Percentages throughout this specification are weight-percentages (wt.-% or weight-%) unless stated otherwise. Yields are given as percentage of the theoretical yield. Concentrations given in this specification refer to the mass of the entire solutions, dispersions or compositions unless stated otherwise. Room temperature means 20° C.

The term “alkyl” according to the present invention comprises branched or unbranched alkyl groups comprising cyclic and/or non-cyclic structural elements, wherein cyclic structural elements of the alkyl groups naturally require at least three carbon atoms. C1-CX-alkyl in this specification and in the claims refers to alkyl groups having 1 to X carbon atoms (X being an integer). C1-C18-alkyl for example includes, among others, methyl, ethyl, n-propyl, iso-propyl, n-butyl, isobutyl, sec-butyl, tert-butyl, n-pentyl, iso-pentyl, sec-pentyl, tert-pentyl, neo-pentyl, hexyl, heptyl and octyl, hexadecyl and octadecyl. The alkyl group is typically not substituted unless specified differently hereinafter. The term “alkanediyl” is the corresponding group having two free valences (bonding sites). Sometimes, it is referred to as “alkylene” in the art. Said residues according to the present invention comprise cyclic and/or non-cyclic structural elements and can be linear and/or branched. C1-C4-alkanediyl for example includes, among others, methane-1,1-diyl, ethane-1,2-diyl, ethane-1,1-diyl, propane-1,3-diyl, propane-1,2-diyl, propane-1,1-diyl, butane-1,4-diyl, butane-1,3-diyl, butane-1,2-diyl, butane-1,1-diyl, butane-2,3-diyl. Usually, unless specified differently hereinafter, the alkanediyl group in not substituted.

The “alkenyl” is an unsaturated alkyl group comprising at least one olefinic (i.e. a C═C-double) bond. Above-described details and preferences for the alkyl groups apply for alkenyl groups mutatis mutandis.

The term “aryl” according to the invention refers to ring-shaped aromatic hydrocarbon residues, for example phenyl or naphthyl. The aryl group is typically not substituted unless specified differently hereinafter.

The term “alkaryl” according to the invention refers to hydrocarbon groups comprising at least one aryl and at least one alkyl group such as benzyl and p-tolyl. The bonding of such an alkaryl group to other moieties may occur via the alkyl or the aryl group of the alkaryl group. Above-described details and preferences for the alkyl and aryl groups apply for alkaryl groups mutatis mutandis.

If more than one residue—being it an atom, a group of atoms or entire building blocks—is to be selected from a given group, each of the residues is selected independently from each other unless stated otherwise hereinafter, meaning they can be selected to be the same members or different members of said group. The bonding sites in some chemical formulae herein may be emphasized by a wavy line (“ [symbol] ”) as it is customary in the art.

Embodiments and preferences described for one aspect of the present invention apply mutatis mutandis for all the other aspects thereof unless technically unfeasible or stated otherwise. The repetition is omitted to improve the conciseness of the specification.

The composition according to the invention comprises
a) at least one bis-silyl compound comprising at least one building block according to formula (A) (said compound will be hereinafter referred to as “bis-silyl compound”) and
b) at least one gliding agent selected from the group consisting of wax, fatty acid and fatty acid ester.

The bis-silyl compound is known in the art and commercially available or can be prepared by known methods. For example, an oligomeric or polymeric bis-silyl compound can be prepared by hydrolysis and condensation of bis-(trialkoxysilylpropyl) amine and optionally one or more aminofunctional silanes such as AMEO. The alcohol obtained during the preparation is preferably removed by distillation.

A polyether group is preferably a —[CH₂—CH(R′)—O]ⱼ—R″ group wherein R′ is selected from the group consisting of hydrogen and methyl group, R″ is selected from the group consisting of hydrogen, alkyl group and aryl group and j is an integer ranging from 1 or 3 to 100, more preferably from 5 to 20.

R^{a1} is preferably selected from the group consisting of hydrogen and C1-C4-alkyl group. More preferably, R^{a1} is hydrogen. R^{a2} is preferably a C1-C8-alkanediyl group, more preferably a C2-C4-alkandiyl group, even more preferably a 1,3-propanediyl group. R^{a3} is preferably selected from the group consisting of hydrogen and C1-C4-alkyl group. More preferably, R^{a3} is hydrogen.

It is particularly preferred that R^{a1} is selected from the group consisting of hydrogen and C1-C4-alkyl group (more preferably each R^{a1} is hydrogen), R^{a2} is a C2-C4-alkandiyl group (each R^{a2} is more preferably a 1,3-propanediyl group) and R^{a3} is selected from the group consisting of hydrogen and C1-C4-alkyl group (each R^{a3} is more preferably hydrogen). This particular preferred selection for 10 the at least one building block according to formula (A) is referred to as particular preferred selection A1. It is even more preferred that R^{a1} is hydrogen, R^{a2} is 1,3-propanediyl group and R^{a3} is hydrogen. This particular preferred selection for the at least one building block according to formula (A) is referred to as particular preferred selection A2.

m is preferably selected from 0, 1 and 2. n is preferably selected from 0, 1 and 2. More preferably, m and n are selected from 0, 1 and 2. Preferably, at least one of m and n is less than 3, more preferably m and n are (both) less than 3.

Preferably, the bis-silyl compound comprises (in addition to the at least one building block according to formula (A)) at least one building block according to formula (B)

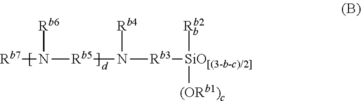

wherein
each R^{b1} is independently selected from the group consisting of hydrogen, alkyl group and aryl group,
R^{b2} is an alkyl group,
R^{b3} is an alkanediyl group,
R^{b4} is selected from the group consisting of hydrogen, alkyl group, aryl group and alkaryl group,
each R^{b5} is independently an alkanediyl group,
each R^{b6} is selected from the group consisting of hydrogen, alkyl group, aryl group and alkaryl group,
R^{b7} is selected from the group consisting of hydrogen and alkyl group,
b is selected from 0 and 1,
c is selected from 0, 1 and 2,
d is selected from 0, 1 and 2,
with the proviso that the sum of b and c ranges from 0 to 2.

Said additional building block according to formula (B) in the bis-silyl compound advantageously further improves the wet scratch resistance of the treated glass surface with the composition and further prevents the occurrence of optical deterioration of the treated glass surface.

In case the bis-silyl compound comprises the at least one building block according to formula (B), at least one of m and n is less than 3.

Preferably, R^{b1} is preferably selected from the group consisting of hydrogen and C1-C4-alkyl group. More preferably, R^{b1} is hydrogen. R^{b2} is preferably a C1-C4-alkyl group, R^{b2} is more preferably a methyl group. R^{b3} is preferably a C1-C8-alkanediyl group, more preferably a C2-C4-alkandiyl group, even more preferably 1,3-propanediyl. R^{b4} is preferably selected from the group consisting of hydrogen, alkyl group and aryl group, more preferably from hydrogen and C1-C4-alkyl group, R^{b4} is even more preferably hydrogen. Preferably, R^{b5} is a C1-C8-alkanediyl group, more preferably a C2-C4-alkanediyl group, even more preferably a 1,2-ethanediyl group. R^{b6} is preferably selected from the group consisting of hydrogen, alkyl group and aryl group, more preferably from hydrogen and C1-C4-alkyl group, R^{b6} is even more preferably hydrogen. R^{b7} is preferably selected from the group consisting of hydrogen, alkyl group and aryl group, more preferably from hydrogen and C1-C4-alkyl group, R^{b7} is even more preferably hydrogen. It is still even more preferred that R^{b4}, R^{b6} and R^{b7} are hydrogen. b is preferably 0. c is preferably selected from 0 and 1. d is preferably 0.

A particular preferred embodiment of the at least one building block according to formula (B) is the building block according to formula (B1):

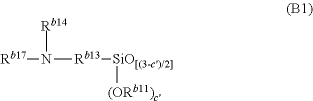

wherein
each R^{b11} is independently selected from the group consisting of hydrogen and C1-C4-alkyl group,
R^{b13} is a C2-C4-alkandiyl group, even more preferably 1,3-propanediyl,
R^{b14} is selected from the group consisting of hydrogen and C1-C4-alkyl group, R^{b14} is even more preferably hydrogen,
R^{b17} is selected from the group consisting of hydrogen and C1-C4-alkyl group, R^{b17} is even more preferably hydrogen, and c′ is selected from 0, 1 and 2. Preference is given to all of R^{b11}, R^{b14} and R^{b17} being hydrogen.

The building block according to formula (B1) is the preferred alternative of the aforementioned building block according to formula (B). It is preferably used as the sole alternative of the latter or (less preferred) both building blocks (B and B1) are used in combination. It is preferred that the at least one bis-silyl compound comprises (or consists of) the at least one building block according to formula (A) employing the aforementioned particular preferred selection A1 and the at least one building block according to formula (B1) because very good results can be obtained. It is more preferred that the at least one bis-silyl compound comprises (or consists of) the at least one building block according to formula (A) employing the aforementioned particular preferred selection A2 and the at least one building block according to formula (B1) because optimal results can be obtained.

The total number of building blocks according to formula (A) and—if present—of building blocks according to formula (B) in the bis-silyl compound preferably ranges from 2 to 1000, more preferably from 3 to 500, even more preferably from 4 to 100, yet even more preferably from 5 to 50. The number or ratio of building blocks can be determined by standard means, e.g. ¹H, ¹³C, and/or ²⁹Si-NMR spectroscopy. The person skilled in the art is aware of further suitable methods such as gel permeation chromatography.

Preferably, the numerical ratio of the building blocks according to formula (A) and the building blocks according to formula (B) in the bis-silyl compound ranges from 1 (building block according to formula (A)) to 0.1-1000 (building blocks according to formula (B)), more preferably 1 to 1-250, even more preferably 1 to 1-50, still even more preferably 1 to 1-10, resulting in optimal wet scratch resistances of treated glass with the composition according to the invention comprising such a bis-silyl compound.

The at least one building block according to formula (A) and—if contained in the bis-silyl compound—the at least one building block according to formula (B) preferably make up for at least 50 weight-%, more preferably 75 weight-%, even more preferably 90 weight-%, of the bis-silyl compound. The bis-silyl compound most preferably consists of the one or more building blocks according to formula (A) and optionally, the one or more building blocks according to formula (B).

Preferably, the at least one bis-silyl compound is an oligomer or a polymer. To that end, at least one of m and n is selected from 0, 1 and 2. An improved crosslinking density of the film obtained from the bis-silyl compound can then be obtained if the at least one bis-silyl compound is an oligomer or a polymer. The improved crosslinking density results in an enhanced dry and wet scratch resistance of the treated surface. An oligomer according to the invention comprises (in total) 2 to 4 building blocks according to formulae (A) and (optionally) (B), a polymer comprises (in total) at least 5 building blocks according to formulae (A) and (optionally) (B). A non-limiting example of an oligomer comprising one building block according to formula (A) and (B) is depicted hereinafter:

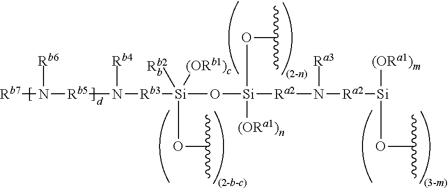

Oligomers and polymers usually comprise one or more of linear, branched and cyclic structures (said structures being formed by the building blocks according to formula (A) and/or (B)). The building blocks described herein can also be understood as structural repeating units if more than one building block according to formula (A) and optionally (B) is comprised by the bis-silyl compound.

The building blocks contained in the at least one bis-silyl compound, i.e. the building blocks according to formulae (A) and—if present—(B), can be arranged in various patterns if the at least one bis-silyl compound is an oligomer or a polymer. The patterns formed by the building blocks can comprise alternating, block and/or random patterns. If more than one building block according to formulae (A) and optionally (B) is comprised by the bis-silyl compound, they are typically bound to each other by a joint oxygen atom between the silicon atoms of the respective building blocks (depicted in the chemical formulae as O_{y/2} where y represents one of (3-m), (3-n), (3-b-c) or (3-c′)).

As used conventionally in the art, the R_{g}—SiO_{(4-g/2)} shall be understood that the depicted silicon atom carries 4−g oxygen atoms (g being an integer ranging from 0 to 4) and g residues R. The oxygen atoms are bound by a single bond to the silicon atom and thus have another substituent such as a silicon atom of a unity named above. In the case of the present invention, the other silicon atom is preferably one of a building block according to formula (A) or (B). If g is 3, a M-unit is present. If g is 2, a D-unit is present. If g is 1, a T-unit is present. If g is 0, a Q-unit is present. This nomenclature is known to the person skilled in the art, e.g. from W. Noll, Chemie und Technologie der Silicone, Verlag Chemie, Weinheim Bergstr., 1960, p. 2 et seqq.

An alternative representation of the building block according to formula (A) is:

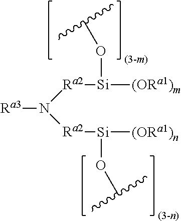

This alternative representation of the building block according to formula (A) highlights the bridging function of the oxygen atoms bound to the silicon atoms that are generally shown as “O (3-m/2)” and “(3-n/2)” in the other depictions of the building block according to formula (A). The free valences of these oxygen atoms (shown with bonds to wavy lines) can be satisfied with any suitable partners, preferably with silicon atoms of other building blocks according to formulae (A) and/or (B). If the free valences are satisfied with silicon atoms of other building blocks according to formulae (A) and/or (B), then the bis-silyl compound is an oligomer or a polymer.

Similarly, an alternative representation of the building block according to formula (B) can be depicted as follows:

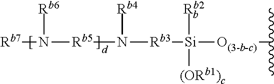

An exemplary oligomer of the bis-silyl compound consisting of 3 building block according to formula (A) is depicted in the following. In this depiction, the three building blocks are highlighted by rectangular boxes with dashed lines to further illustrate the concept of building blocks. The building blocks are joined by bridging oxygen atoms.

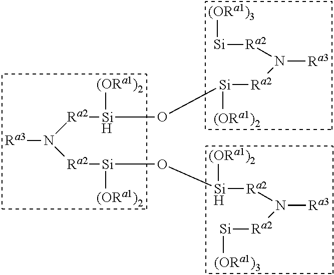

As described hereinbefore, the bis-silyl compound can be prepared by reacting bis-(trialkoxysilylpropyl) amine and optionally one or more aminofunctional silanes such as AMEO and allowing them to condense. By said condensation of the aforementioned silanes, alkoxy groups are cleaved in favor of the formation of siloxane bonds (“Si—O—Si”) that are depicted above. These siloxane bond comprise the bridging oxygen atom placed between two silicon atoms of the respective building blocks.

Preferably, the amount of the at least one bis-silyl compound in the composition ranges from 0.001 to 10 weight-%, preferably from 0.01 to 4 weight-%, more preferably from 0.05 to 1 weight-%, even more preferably from 0.1 to 0.8 weight-%, based on the total composition. If more than one bis-silyl compound is comprised in the composition, the amount of all bis-silyl compounds preferably lies in above-defined ranges.

The composition according to the invention comprises at least one gliding agent. The at least one gliding agent is selected from the group consisting of wax, fatty acid and fatty acid ester. Preferably, the at least one gliding agent is a wax, more preferably the at least one gliding agent is selected from the group consisting of amide wax, polyolefin wax and copolymer thereof, even more preferably selected from the group consisting of polyolefin wax and copolymer thereof, yet even more preferably a polyolefin wax, still even more preferably a polyethylene wax. The outlined preferences allow for an increasing scratch resistance and an improved stability of the composition according to the invention. In addition, the fatty acid and the fatty acid ester do not give as lasting effects as the wax when used as the at least one gliding agent.

The wax is preferably selected from natural waxes and synthetic waxes. Natural waxes include recent waxes such as beeswax, carnauba wax or candelilla wax, fossil waxes such as montan wax or derivatives thereof and petroleum waxes (both paraffin waxes and microwaxes).

Synthetic waxes are preferably selected from the group consisting of Fischer-Tropsch waxes, polyolefin waxes (such as polyethylene wax, polypropylene wax, polyisobutylene wax and copolymers thereof), amide waxes (e.g. N,N′-distearoylethylenediamine), polyethylene glycol wax and polypropylene glycol wax. More preferably, the synthetic wax is a polyolefin wax or a copolymer thereof, even more preferably a polyolefin wax, still even more preferably a polyethylene wax.

Non-polar waxes such as petroleum waxes, Fischer-Tropsch waxes and polyolefin waxes such as polyethylene waxes are preferably, in the interests of better dispersibility, used in their oxidized form. Such oxidized waxes have been known for a long time and can be prepared by standard means.

For the purposes of the invention, particular preference is given to polyethylene waxes (also occasionally referred to as “polyethylene” in the art). The polyethylene wax used generally has a number average molecular weight (Mn) in the range from 400 to 20,000 g/mol (as measured by GPC, PLgel column (Agilent), solvent: 1,2,4-trichlorobenzene+0.015 wt % butylated hydroxytoluene, 160° C., using polyethylene standards provided by Agilent). Preferably, the Mn is in the range from 500 to 15,000 g/mol and more preferably from 1000 to 8000 g/mol. Said ranges result in improved stabilities of the composition according to the invention and enhanced scratch resistances.

It is preferred that the melting point of the polyethylene wax ranges from 50 to 170° C., preferably from 80 to 150° C., more preferably from 100 to 135° C. The melting point is measured in according with DIN 51532 (2012). Said ranges result in improved stabilities of the composition according to the invention and enhanced scratch resistances.

The polyethylene optionally has a certain degree of branching which can also result, in the case of short chain branching, from the use of olefinic comonomers such as propene, 1-butene or 1-hexene.

There are plenty of methods known to the person skilled in the art of how to prepare polyethylene waxes. Various types thereof are commercially available, also in the form of aqueous dispersions. Exemplarily, they can be prepared by thermal and, if appropriate, free-radical degradation of a higher molecular weight polyethylene or else by polymerization of ethylene, either by a free radical mechanism or by means of a transition metal catalyst.

To improve the dispersibility of polyethylene waxes and thus the stability of the composition according to the invention, it is advantageous to use copolymers thereof comprising comprise 50 mol-% or more of ethylene and 50 mol-% or less of a polar monomer, for example ethylene-vinyl acetate copolymer waxes or copolymers of ethylene and acrylic acid. Another possible way of preparing dispersible polyethylene is to graft polyethylene in the melt with an unsaturated polar monomer, for example with maleic anhydride. For this purpose, it is generally useful to add a free-radical initiator. The polyethylene which has been modified in this way advantageously can, if desired after further modification, easily be converted by customary methods into a nonionic, anionic or cationic dispersion, usually with addition of one or more emulsifiers (also referred to as “surfactants” in the art, vide infra).

The polyethylene wax is preferably selected from the group consisting of non-modified polyethylene wax, a copolymer of polyethylene and a polyethylene grafted with at least one polar monomer. More preferred, it is selected from the group consisting of a copolymer of polyethylene and a polyethylene grafted with at least one polar monomer. These preferred polyethylene waxes are preferably used in their oxidized form as described hereinbefore.

There are many commercially available (partial) fatty acid esters that can used as the at least one gliding agent, preferably the so-called ester waxes. Preferable examples include stearic acid esters of ethylene glycol, diethylene glycol, polyethylene glycol or 1,4-butanediol or glyceryl tristearate and also mixed partial esters of mannitol with stearic acid and palmitic acid.

Suitable fatty acids as the at least one gliding agent have the structure Rx-COOH, where R^{x} is a C10-C22-alkyl or C10-C22-alkenyl group. Preferable examples are oleic acid, stearic acid, palmitic acid and lauric acid.

It is possible within the context of the present invention that a mixture of gliding agents is employed. For instance, a wax and a fatty acid or a wax and a (partial) fatty acid ester or any other combination can be used as the at least one gliding agent.

The amount of the at least one gliding agent in the composition preferably ranges from 0.01 or 0.05 to 5 weight-%, more preferably from 0.1 to 2 weight-%, based on the composition. In case more than one gliding agent is used in the composition, the total amount of all gliding agents preferably lies in above ranges.

It is preferred that the composition according to the invention—in addition to the at least one bis-silyl compound-comprises at least one silane-based compound comprising at least one building block according to formula (I)

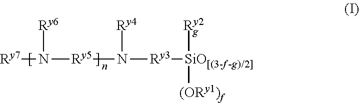

wherein
   each R^{y1} is independently selected from the group consisting of hydrogen, alkyl group, polyether group and aryl group,
   R^{y2} is an alkyl group,
   R^{y3} is an alkanediyl group,
   R^{y4} is selected from the group consisting of hydrogen, alkyl group, aryl group and alkaryl group,
   each R^{y5} is independently an alkanediyl group,
   R^{y6} is selected from the group consisting of hydrogen, alkyl group, aryl group and alkaryl group,
   R^{y7} is selected from the group consisting of hydrogen and alkyl group,
   f is selected from 0, 1 and 2
   g is selected from 0 and 1,
   h is selected from 0, 1 and 2,
with the proviso that the sum of f and g preferably ranges from 0 to 2.

The silane-based compound further improves the wet scratch resistance. The silane-based compound preferably does not comprise any building blocks according to formula (A).

R^{y1} is preferably selected from the group consisting of hydrogen and C1-C4-alkyl group.

R^{y3} is preferably a C2-C4-alkandiyl group.

R^{y4} is preferably selected from the group consisting of hydrogen and C1-C4-alkyl group.

R^{y7} is preferably selected from the group consisting of hydrogen and C1-C4-alkyl group.

g is preferably 0. h is preferably 0.

In a preferred embodiment of the present invention, R^{y1} is selected from the group consisting of hydrogen and C1-C4-alkyl group;
R^{y3} is a C2-C4-alkandiyl group;
R^{y4} is selected from the group consisting of hydrogen and C1-C4-alkyl group;
R^{y7} is selected from the group consisting of hydrogen and C1-C4-alkyl group;
g is 0; f is selected from 0, 1 and 2; and h is 0.

The at least one building block according to formula (I) preferably makes up for at least 50 weight-%, more preferably 75 weight-%, even more preferably 90 weight-%, of the silane-based compound. The silane-based compound most preferably consists of the one or more building blocks according to formula (I). The number or ratio of building blocks can be determined by standard means, e.g. ¹H, ¹³C, and/or ²⁹Si-NMR spectroscopy. The person skilled in the art is aware of further suitable methods such as gel permeation chromatography.

In the composition according to the invention, the amount of the silane-based compound preferably ranges from 0.001 to 20 weight-%, more preferably from 0.01 to 8 weight-%, even more preferably from 0.05 to 2 weight-%, yet even more preferably from 0.1 to 1.6 weight-%, based on the total composition.

The silane-based compound is known in the art and commercially available. A useful preparation method is inter alia described in US 2018/127442 A1 (in particular paragraphs 11 to 41 and the examples 1, 2 and 3).

The at least one silane-based compound is preferably an oligomer or a polymer for the same reasons outlined for the at least one bis-silyl compound. The details described for the building block patterns described for the at least one bis-silyl compound apply mutatis mutandis for the at least one silane-based compound.

The weight ratio of the at least one silane-based compound and the at least one bis-silyl compound—if the first-mentioned compound is present in the composition according to the invention—preferably ranges from 0.1 to 0.9, more preferably 0.2 to 0.8, even more preferably from 0.3 to 0.7.

The composition according to the invention preferably comprises water, preferably in an amount of 1 to 99.99 weight-%, more preferably 10 to 99.9 weight-%, even more preferably 50 to 99.7 weight-%, yet even more preferably 90 to 99.6 weight-%, based on the total composition.

The composition according to the invention preferably comprises at least one acid. The at least one acid further improves the stability of the composition. Acids are typically Brønsted acids having a pKₐ value sufficiently high to transfer a proton onto another component in the composition. The at least one acid is typically selected from inorganic acids and organic acids. Preferred inorganic acids are selected from the group consisting of nitric acid, hydrochloric acid, methanesulfonic acid and mixtures of the aforementioned.

Organic acids are preferred and preferably selected from the group consisting of monocarboxylic acids and dicarboxylic acids. Said acids are preferably unsubstituted. Monocarboxylic acids are more preferred as the at least one acid because they surprisingly improve the wetting of the glass surface of the substrate and therefore, improve the beneficial effects of the present invention. Even more preferably, the at least one acid is a monocarboxylic acid having one to four carbon atoms, the at least one acid is still even more preferably selected from acetic acid and formic acid. Most preferred is formic acid in this context as it excels in this regard.

The amount of the at least one acid may be based inter alia on the amine number of the at least one bis-silyl compound (and if present the amine number of the at least one silane-based compound). Preferably, the amount of the at least one acid ranges from 0.00001 to 10 weight-%, more preferably from 0.01 to 1 weight-%, even more preferably from 0.2 to 0.1 weight-%, based on the total composition.

The pH value of the composition according to the invention usually ranges from 1 to 14. The pH value of the composition according to the invention probably ranges from 1 to 7, more preferably from 3.5 to 6.8, even more preferably from 4.5 to 6.5. Said pH ranges advantageously improve the stability of the composition according to the invention. The preferred pH value ranges avoid a potential glass corrosion in case the substrate to be treated comprises a glass surface and it was found that the scratch resistance may deteriorate in some cases if the composition has a pH value of >7.

The composition optionally comprises at least one organic solvent. Any organic solvent suitable to dissolve or disperse the components of the composition can be employed. The at least one organic solvent is preferably a polar solvent, more preferably an alkanol, even more preferably a C1-C4-alkanol such as methanol and ethanol. If present in the composition according to the invention, the one or more optional organic solvents is preferably contained in a total amount of 25 weight-% or less, more preferably in an amount of 20 weight-% or less, even more preferably in an amount of 15 weight-% or less, yet even more preferably 1.0 weight-% or less, still even more preferably 0.25 weight-% or less, based on the total composition. Ideally, the amount thereof is less than 0.1 weight-% as this further improves the ecological effects of the present invention. In particular (for ecological and safety reasons), the amount of alkanols in the composition according to the invention preferably is 1 weight-% or less, preferably 0.25 weight-% or less, ideally 0.1 weight-% or less, based on the total composition according to the invention.

The composition is preferably a dispersion. A dispersion in the context of the present invention is preferably an emulsion or a suspension. Preference is given to it being an emulsion facilitating treatment of the at least one glass surface therewith, in particular if the composition is applied by spraying due to the avoidance of clogging of the nozzles of the spray application device.

Generally, and especially in case the composition is a dispersion (e.g., an emulsion), the composition according to the invention preferably comprises at least one emulsifier (also referred to as surfactant or wetting agent in the art). The at least one emulsifier and its amount can be selected based on the general knowledge of the person skilled in the art and routine experiments. The at least one emulsifier is preferably contained in the composition according to the invention in an amount of 0.01 to 10 wt.-%, more preferably 0.1 to 2.5 wt.-%, even more preferably 0.2 to 1.0 wt.-%, based on the total composition according to the invention. If more than one emulsifier is contained, the overall amount of all emulsifiers preferably lies in above-defined ranges. Preferably, the at least one emulsifier has a HLB value of 8 or above, more preferably of 11 or above.

Useful emulsifiers are selected from the group consisting of non-ionic, anionic, cationic, amphoteric emulsifiers and mixtures of the aforementioned. The at least one emulsifier is preferably selected from the group consisting of non-ionic, anionic, cationic emulsifiers and mixtures of the aforementioned, more preferably selected from the group consisting of non-ionic and cationic emulsifiers and mixtures of the aforementioned.

Preferable examples for non-ionic emulsifiers are represented by formula (E):

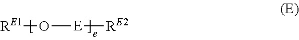

wherein
R^{E1} is a C8-C22-alkyl group;
R^{E2} is selected from the group consisting of hydrogen, alkyl group, hydroxyl group and oxyalkyl
group;
each E independently is an alkanediyl group; and
e is an integer ranging from 1 to 100.

R^{E1} is preferably a C10-C18-alkyl group, more preferably a C12-C16-alkyl group. Preferably, R^{E1} is a branched alkyl group. Most preferably, R^{E1} is an iso-C13-alkyl group. R^{E2} is preferably selected from the group consisting of, hydroxyl group, oxymethyl group and methyl group. More preferably, R^{E2} is a hydroxyl group. E is preferably selected from the group consisting of 1,2-ethanediyl group, 1,2-propanediyl group and 1,3-propanediyl group. e preferably ranges from 2 to 10, preferably from 3 to 7, more preferably from 4 to 6.

Preferably, the anionic emulsifier is represented by formula (L)

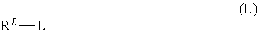

wherein
R^{L} is a C8-C22-alkyl group; and
L is selected from the group consisting of carboxylic acid group (—CO₂H), sulfonic acid group (—SO₃H) and phosphonic acid group (—PO₃H₂) or a salt thereof.

R^{L} is preferably a C10-C18-alkyl group, more preferably a C12-C16-alkyl group. Preferably, R^{L} is a branched alkyl group. L is preferably a sulfonic acid group or a salt thereof. The anionic emulsifier is less preferred as the preferred pH value ranges of the composition according to the invention defined above may cause the anionic emulsifier to lose its water-solubility and hence, may result in less stable compositions.

A cationic emulsifier is preferably represented by formula (T)

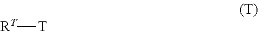

wherein
R^{T} is a C8-C22-alkyl group; and
T is a cationic group, preferably a —NR^{k}₄⁺ group with R^{k} being hydrogen or an alkyl group (which is preferred) such as methyl group or ethyl group. R^{T} is preferably a C10-C18-alkyl group, more preferably a C12-C16-alkyl group.

Preferably, the composition according to the invention comprises colloidal silica, preferably in an amount ranging from 0.01 to 1 weight-%, preferably from 0.05 to 0.5 weight-%, more preferably from 0.1 to 0.25 weight-%, based on the total weight of the composition (and the solids content of the colloidal silica if a dispersion is used). The size (d₅₀) of the silica particles preferably ranges from 10 to 250, more preferably 20 to 100 nm. The d₅₀ value can be measured by dynamic light scattering using preferably a Malvern Panalytical in accordance with ISO 22412:2017-02. The colloidal silica may improve the stability of the composition according to the invention.

Optionally, the composition according to the invention comprises an organic polymer selected from the group consisting of polyurethane, polyesters, polymethacrylates and mixtures and copolymers of the aforementioned. The amount of the organic polymer preferably ranges from 0.01 to 10 weight-%, preferably from 0.1 to 5 weight-%, more preferably from 0.25 to 1 weight-%. The organic polymer enhances the adhesion of labels, paints or inks applied to the surface after applying the composition according to the invention.

The solids content of the composition according to the invention preferably ranges from 0.01 to 15%, more preferably from 0.05 to 10%, even more preferably from 0.1 to 1%.

In one embodiment of the present invention, the composition according to the invention comprises (or consists of)
I) the at least one bis-silyl compound;
II) the at least one gliding agent;
III) the at least one emulsifier;
IV) preferably, the at least one acid; and
V) water.

The named components are preferably comprised in the composition according to the invention in the amount described hereinbefore.

In a further embodiment of the present invention, the composition according to the invention comprises (or consists of)
I) the at least one bis-silyl compound;
II) the at least one gliding agent;
III) the at least one emulsifier;
IV) preferably, the at least one acid;
V) water and
VI) the at least one silane-based compound.

The named components are preferably comprised in the composition according to the invention in the amount described hereinbefore.

Preferably, the composition according to the invention does not comprise any polyisocyanates in an amount of 0.1 weight-% or above. More preferably, the compositions according to the invention is free of polyisocyanates. Polyisocyanates negatively affect the stability of the composition according to the invention. Polyisocyanates in the context of the present invention are compounds having at least two isocyanate groups (either free or blocked, e.g. oxime-blocked). Such polyisocyanates are described inter alia in U.S. Pat. No. 6,403,175 (col. 8, I. 1-col. 9, I. 7).

The composition according to the invention can be prepared by standard and known means in the art. Exemplarily, the components described hereinbefore can be mixed in a suitable vessel employing standard means. The present invention further pertains to a method of preparing the composition according to the invention comprising mixing the at least one bis-silyl compound, the at least one gliding agent and optionally the at least one emulsifier, optionally the at least one acid and optionally water (and optionally the aforementioned further optional components described herein) in a suitable vessel to give the composition according to the invention.

It is also possible within the means of the present invention to prepare the bis-silyl compound as described in US 2011/02688911 A1 (see in particular paragraphs 17 to 174 and examples 1 to 41 thereof) and to add any possible further components before, during or after its preparation and thereby, to obtain the composition. It is preferable to disperse the at least one gliding agent before adding it to the at least one bis-silyl compound.

In another aspect, the present invention concerns a kit-of-parts for preparing the composition according to the invention, said kit-of-parts comprising a part A and a part B wherein part A comprises the at least one bis-silyl compound and part B comprises the at least one gliding agent. By mixing part A and part B of the kit-of-parts according to the invention, the composition according to the invention can be easily prepared. Mixing part A and part B can be accomplished by employing standard means (vide supra). The composition thus obtained may optionally be diluted with water and optionally with the at least one solvent. Preference is given to water (alone) for the reasons laid out above.

Part A preferably comprises water. Part A optionally comprises the at least one solvent (if present). Part A of the kit-of-parts according to the invention preferably comprises the at least one acid.

Part B preferably comprises water. Part B of the kit-of-parts according to the invention preferably comprises the at least one emulsifier.

The kit-of-parts according to the invention preferably comprises
a part A comprising the at least one bis-silyl compound, water and the at least one acid; and
a part B comprising the at least one gliding agent, water and the at least one emulsifier.

More preferably, the kit-of-parts according to the invention comprises (or consists of)
a part A comprising the at least one bis-silyl compound, the at least one silane-based compound, water and the at least one acid; and
a part B comprising the at least one gliding agent, water and the at least one emulsifier.

As can be expected, the concentrations of the components in parts A and B of the kit-of-parts according to the invention may deviate from those described for the composition according to the invention.

The kit-of-parts according to the invention offers two advantages. The parts have a very long shelf-life and can be stored for prolonged period of time, even at elevated temperatures such as 40° C. And the kit-of-parts allows for a simple preparation method of the composition according to the invention and does not require any special equipment.

The present invention further concerns a method for treating at least one glass surface of a substrate comprising the method steps
a) providing the substrate comprising the at least one glass surface; and
b) treating said at least one glass surface with the composition according to the invention; such that a treated glass surface is obtained.

The inventive method comprises method steps a) and b). These method steps are carried out in the given order. The inventive method optionally comprises further method steps to be carried out before, after and/or between said method steps.

In method step a) of the inventive method, the substrate comprising the at least one glass surface is provided. The substrate is not particularly limited in its form or function as long as it comprises the at least one glass surface. Preferably, the substrate is made in its entirety out of glass. In one embodiment of the present invention, the substrate consists of the at least one glass surface.

The substrate comprising the at least one glass surface is preferably a hollow container, more preferably selected from the group consisting of bottle, thermos, ampule, tube, jar, vial and flask.

Glass in the context of the present invention is not particularly limited. Glass includes soda lime silicate glass, alumosilicate glass, borosilicate glass, alumoborosilicate glass, silica glass, and the like but also, albeit not preferred, non-silicated glass.

Optionally, the method comprises a further method step after method step a) and before method step b):
a.i) cleaning the at least one glass surface.

There is a multitude of methods available to the person skilled in the art aiming inter alia at removing dirt and grease from the at least one glass surface. For example, the at least one glass surface can be cleaned chemically. Chemical cleaning includes inter alia treating said surface with an (alkaline) aqueous solution comprising a suitable surfactant and/or oxidant. Alternatively, it can be wiped with a cloth, said cloth optionally containing aforementioned aqueous solution.

In method step b) of the method according to the invention, the at least one glass surface is treated with the composition according to the invention. The at least one glass surface is treated entirely or only one or more parts thereof are treated with the composition according to the invention.

The temperature of the at least one glass surface in method steps b) preferably ranges from 20 to 200° C., more preferably from 60 to 150° C., even more preferably from 100 or 110 to 130° C. The glass surface thus does not require to be heated to an as high temperature as in the case of the commonly used tin compounds. The method according to the invention therefore saves energy and is more environmentally benign.

Optionally, the temperature of the composition is adjusted to a value ranging from 10 to 80° C., preferably 20 to 30° C., prior to it being used for the treating the at least one glass surface therewith.

In general, it is advisable to keep the temperature difference between the composition and the glass surface in certain ranges. For example, a temperature difference between the composition and the glass surface of 100° C. or above should be avoided. Otherwise, the glass surface may suffer from the treatment resulting in breakages or the like. Temperature differences that may be tolerated depend in particular on the type of glass used. The person skilled in the art is aware of this and is able to select suitable temperatures based on his general knowledge or based on routine experiments.

The at least one glass surface is treated with the composition by common means. Preferably, the treatment of the at least one glass surface in method steps b) is performed by means of spraying, dipping, rolling, painting and combinations of the aforementioned. Particular preference is given to spraying.

Preferably, the inventive method does not employ any tin compounds such as tin salts like n-butyltin trichloride and tin tetrachloride. To that end, the composition is preferably free of (intentionally added) tin compounds. This means that the content of tin compounds in the composition according to the invention is preferably 0.1 weight-% or less, more preferably 0.01 weight-% or less, even more preferably 0.001 weight-%. Ideally, it is completely free of tin compounds. Particularly, the inventive method does not employ any tin compounds to bind the at least one gliding agent to the at least one glass surface. The omission of tin compounds such as tin salts is environmentally and toxicologically advantageous as already outlined hereinbefore.

In still another aspect, the present invention further is directed at a substrate comprising
i) at least one glass surface; and
ii) at least one layer obtained by treating the at least one glass surface with the composition according to the invention (hereinafter referred to as “layer ii)”).

Layer ii) is obtained by treating the at least one glass surface with the composition according to the invention. The layer ii) proved difficult to characterize. It is believed by the inventors of the present invention that a multitude of compounds derived from the at least one bis-silyl compound are present in layer ii). The substrate optionally comprises one or more than one further layers to be located underneath or on top of layer ii), preferably the optional further layer is located on top of layer ii). Layer ii) is preferably arranged directly on the at least one glass surface. Layer ii) is present on the entire glass surface or only on one or more parts thereof. Optionally, the substrate comprises one or more adhesive layers on layer ii). Conventionally used adhesives can be used for this purpose without limitation. On the optional adhesive layer a label is optionally located. The label is usually made of paper or the like. For decorative or informative purposes, it may be printed on its side facing away from the glass surface.

Preferably, the substrate is a hollow container, more preferably a hollow container selected from the group consisting of bottle, thermos, ampule, tube, jar, vial and flask.

In one preferred embodiment of the present invention, the substrate is selected from the group consisting of bottle, thermos, ampule, tube, jar, vial and flask and comprises the at least one glass surface, the layer ii) on the at least one glass surface, the adhesive layer on the layer ii) and the label on the adhesive layer.

In still another aspect of the present invention, the substrate, especially the hollow container as the substrate, according to the invention is used to store a fluid or a solid, preferably a fluid, more preferably a liquid, even more preferably a beverage such as water therein.

The invention will now be illustrated by reference to the following non-limiting examples.

### EXAMPLES

Commercial products were used as described in the technical datasheet available on the date of filing of this specification unless stated otherwise hereinafter. The most recent versions of standards were used unless stated differently hereinafter.

As glass substrates untreated 1 I soda lime silicate glass bottles were used in all experiments. As hand applicator, a spray gun (IPOTOOLS Mini HLVP Spray Gun) was used.

The following products were used as gliding agents in the following experiments:

| Product name | pH value | Solids content [%] | supplier |
|---|---|---|---|
| Tegoglas ® RP40LT | 8.5-10 | 23.5 | Arkema |
| Tegoglas ® 702 | Around 7 | ca. 22 | Arkema |
| Glasskote ® SC 100 | 8.5-10 | ca. 18 | TotalEnergies |
| Tegoglas ® RP40 | ca. 7-9 | ca. 23.5 | Arkema |

All gliding agents were aqueous dispersions of oxidized or partially oxidized polyethylene.

### Tests Methods

### Dry and Wet Scratch Resistance—Scratch Test

The scratch resistance was tested by rubbing the surfaces of two coated glass bottles against each other, one bottle in each hand. The test was repeated several times at various areas on the glass bottles by at least two individuals. Instances of scratching or sliding resistance were recorded. The wet scratch resistance was tested in the same way as the dry scratch resistance but with a glass surface wetted with water beforehand. To that end, the glass surface was wetted under rinsing water. The pressure and scratch time (15 s) were kept constant.

Ranking: no scratches: 1, slight scratches: 2, scratches over entire test surface: 3

### Optical Appearance

The optical appearance was visually inspected by at least two individuals. The optical appearance was ranked via the turbidity with the following criteria: clear (1), slightly turbid (2) and turbid (3).

### Determination of Dry Residue (Solids Content):

The solids content (also referred to as dry residue) of the formulations was determined as follows: 1.000 g of the sample was weighed out into a small porcelain dish and dried until weight constancy in a drying oven at 105° C.

### Determination of the Amine Content

150-400 mg sample (depending on the amine content) were weighed into an 150 ml beaker and dissolved with 90 ml acid (conc.). The resulting solution was titrated with perchloric acid-solution in acetic acid (c(HClO₄)=0.1 Mol/l with potentographic detection. The factor of the perchloric acid solution was determined with potassium hydrogenphtalate.

### Calculation:

$${NH}_{2} [ \% ] = \frac{100 * V * c * f * 16.02}{E}$$

$$V = mL perchloric acid$$

$$c = concentration of perchloric acid in mol / l$$

$$f = factor of perchloric acid$$

$$E = sample quantity in g$$

### Determination of Free Alcohol Content in the Composition:

The alcohol determination was carried out by means of gas chromatography (Column: RTX 200 (60 m), Temperature program: 90° C. for 10 min-25° C./min to 240° C., Detector: FID, Injection volume: 1.0 μl, internal standard: 2-butanol).

The pH value was measured in accordance to DIN EN ISO 10523 (2012).

The viscosity was measured in accordance to DIN 53015 (2019).

### PREPARATION EXAMPLES

### Comparative Preparation Example 1

A reactor was charged with 80.0 g of water under nitrogen atmosphere. 20.0 g (3-aminopropyl)triethoxysilane were added thereto. The reaction mixture was stirred for 3 hours at 60° C. until the silane was fully hydrolyzed. The thus obtained formulation comprising a silane oligomer formed a clear colorless liquid and had the following analytical and physical data:
Solids content: 7.4 weight-%
Free ethanol content: 13 weight-%
Amine content as NH₂: 1.5 weight-%
Viscosity: 3.0 mPas
pH: 11.0

### Comparative Preparation Example 2

Comparative example 1 was repeated using 80 g of an aqueous solution containing 5.4 g of a 85 weight-% formic acid instead of water. The thus obtained formulation comprising a silane oligomer formed a clear colorless liquid and had the following analytical and physical data:
Solids content: 12 weight-%
Free ethanol content: 13 weight-%
Amine content as NH₂: 1.48 weight-%
Viscosity: 2.9 mPas
pH: 4.5

### Comparative Preparation Example 3

Comparative example 1 was repeated using 20 g (3-Aminopropyl) dimethoxymethylsilane instead of the aforementioned silane. The thus obtained formulation comprising a silane oligomer formed a clear colorless liquid and had the following analytical and physical data:
Solids content: 14.4 weight-%
Free methanol: 7.9 weight-%
Amine content as NH₂: 1.97 weight-%
Viscosity: 3 mPas
pH: 11.2

### Preparation Example 1: Preparation of Bis-Silyl Compound 1

A reactor was charged with 300 g deionized (DI) water and 5.8 g of an aqueous solution of formic acid (85 wt %) and heated to 65° C. 45 g bis [3-(triethoxysilyl) propyl]amine were added to said solution within 30 min. The reaction mixture was stirred for 3 hours at 65° C. until the silane was fully hydrolyzed. If necessary, the pH value was adjusted to around 4.3 with formic acid (using above-named aqueous formic acid solution). Then, around 60 g of ethanol/water were removed under reduced pressure (130-200 mbar). The resulting solution was—if necessary—diluted with DI water to give 300 g of the solution. The thus obtained solution comprising a bis-silyl compound formed a clear yellowish liquid and had the following analytical and physical data:
Solids content: 8.9 weight-%
Free ethanol content: 1.6 weight-%
Amine content as NH₂: 0. 48%
pH: 4.3

### Preparation Example 2: Preparation of Silane-Based Compound 1

A 4-neck-flask equipped with stirrer, dropping funnel, distillation column with bridge was charged with 340.2 g DI water in a nitrogen atmosphere. The water was heated to 40° C. prior to slowly adding 340.0 g 3-aminopropyltriethoxysilane. The temperature of the reaction mixture rose to about 63° C. After complete addition of the 3-aminopropyltriethoxysilane, the pressure was decreased immediately. At a reduced pressure of 106 to 105 mbar, 371.9 g of ethanol/water were distilled off within 4.75 h (hydrolysis alcohol+75%). After about 134.9 g had been distilled off, a total of 78.3 g of DI water were added dropwise during the distillation for dilution within 2.5 h. The reaction mixture was colorless, clear and nonviscous during and towards the end of the distillation. There were no precipitates and deposits whatsoever at the edge of the flask. After cooling, the system was vented with nitrogen. The yield was 389.7 g of clear colorless product.
Solids content 44.7 weight-%
Free ethanol content 0.3 weight-%

### Mixture 1 (Containing the at Least One Bis-Silyl Compound and the at Least One Silane-Based Compound):

A reactor was charged with 192.81 g DI water and 113.64 g preparation example 2. The mixture was stirred and 26.90 g of an aqueous solution of formic acid (85 weight-%) were slowly added. Upon complete addition of the formic acid, 666.66 g preparation example 1 were added and the thus resulting mixture was stirred for another 10 min.

### Stability Tests

A 200 ml glass bottle equipped with magnetic stirrer bar was charged with Mixture 1 and diluted with deionized water in the amounts given below. Then, 2.0 g gliding agent were added prior to shaking the bottle until the content became homogeneous. The bottles were stored at 20° C. for 1 week and checked regularly for their appearance and stability. The results are given in the following table.

TABLE 1
Results of the stability tests.

| | Mixture 1 | Water | Gliding | Optical appearance | | |
|---|---|---|---|---|---|---|
| # | [g] | [g] | agent | ½ h | 24 h | 1 week |
| A | 2.5 | 195.5 | Tegoglas ® | Slightly | Slightly | Slightly |
| | | | RP40LT | opaque, | opaque, | opaque, |
| | | | | transparent | transparent | transparent |
| B | 2.5 | 195.5 | Tegoglas ® | clear | Clear | Clear |
| | | | 702 | | | |
| C | 2.5 | 195.5 | Glasskote ® | Opaque, not | Opaque, not | Opaque, not |
| | | | SC 100 | transparent | transparent | transparent |
| D | 2.5 | 195.5 | Tegoglas ® | turbid, not | turbid, not | turbid, not |
| | | | RP40 | transparent | transparent | transparent |
| E | 5.0 | 193.0 | Tegoglas ® | Slightly | Slightly | Slightly |
| | | | RP40LT | opaque, | opaque, | opaque, |
| | | | | transparent | transparent | transparent |
| F | 5.0 | 193.0 | Tegoglas ® | clear | clear | clear |
| | | | 702 | | | |
| G | 5.0 | 193.0 | Glasskote ® | Opaque, not | Opaque, not | Opaque, not |
| | | | SC 100 | transparent | transparent | transparent |
| H | 5.0 | 193.0 | Tegoglas ® | turbid, not | turbid, not | turbid, not |
| | | | RP40 | transparent | transparent | transparent |

The compositions were sufficiently stable to be used for glass treating purposes. The composition comprising Tegoglas® RP40 was turbid but was still sufficiently stable to be used for treating glass (entries D and H, see Application examples).

### Glass Treatment Method

The glass substrates were treated by spray coating with a hand applicator. To that end, the bottle was placed on a rotating tray and rotated twice while the entire surface of the bottle was treated. The bottles were heated in an oven to the temperatures given below prior to the described treatment. The spray conditions were:
Nozzle diameter: 0.8 mm
Application pressure: 4.5 bar
Spray distance: 20-30 cm
Spray amount: 20 ml/min
rotation duration about 6-7 seconds
bottle temperature 120-124° C.

### Application Examples 1-4 (According to the Invention)

A 200 ml glass bottle equipped with magnetic stirrer bar was charged with 2.5 g Mixture 1 and 195.5 g deionized water. Then, 2.0 g gliding agent were added prior to shaking the bottle until homogeneous. The pH values of the thus obtained compositions ranged from 6.0 to 6.5. The thus obtained compositions were used to treat glass bottles as described above after 0.5 h and 24 h storage time at room temperature, respectively. The results are given in the following table.

TABLE 2
Test Results of Application Examples 1-4.

| | Gliding | Storage | | Dry scratch | Wet scratch | Optical |
|---|---|---|---|---|---|---|
| # | agent | time | | resistance | resistance | appearance |
| 1a | Tegoglas ® | 0.5 | h | 2 | 2 | 1 |
| | RP40LT | | | | | |
| 1b | Tegoglas ® | 24 | h | 1 | 1 | 1 |
| | RP40LT | | | | | |
| 2a | Tegoglas ® | 0.5 | h | 2 | 2 | 1 |
| | 702 | | | | | |
| 2b | Tegoglas ® | 24 | h | 1 | 1 | 1 |
| | 702 | | | | | |
| 3a | Glasskote ® | 0.5 | h | 1 | 1 | 1 |
| | SC 100 | | | | | |
| 3b | Glasskote ® | 24 | h | 1 | 1 | 1 |
| | SC 100 | | | | | |
| 4a | Tegoglas ® | 0.5 | h | 1 | 1 | 1 |
| | RP40 | | | | | |
| 4b | Tegoglas ® | 24 | h | 1 | 1 | 1 |

RP40

### Application Examples 5-8 (According to the Invention)

A 200 ml glass bottle equipped with magnetic stirrer bar was charged with 5.0 g Mixture 1 and 193.0 g deionized water. Then, 2.0 g gliding agent were added prior to shaking the bottle until homogeneous. The pH values of the obtained composition ranged from 6.0 to 6.5. Then, the obtained compositions were used to treat glass bottles after 0.5 h storage time at room temperature. The results are given in the following table.

TABLE 3
Test Results of Application Examples 5-8.

| | Gliding | Storaget | | Dry scratch | Wet scratch | Optical |
|---|---|---|---|---|---|---|
| # | agent | time | | resistance | resistance | appearance |
| 5 | Tegoglas ® | 0.5 | h | 1 | 1 | 1 |
| | RP40LT | | | | | |
| 6 | Tegoglas ® | 0.5 | h | 1 | 1 | 1 |
| | 702 | | | | | |
| 7 | Glasskote ® | 0.5 | h | 1 | 1 | 1 |
| | SC 100 | | | | | |
| 8 | Tegoglas ® | 0.5 | h | 1 | 1 | 1 |

RP40

### Comparative Application Example 1 (One-Step Approach)

An application mixture was prepared by providing 98 weight-% of water and adding aminopropyltriethoxysilane (AMEO) in the concentrations given in the following table and 1 weight-% of Glasskote® SC 100 while stirring. The thus obtained application mixture was the used to treat glass bottles. The results are given in the following table.

TABLE 4
Test Results of Comparative Application Example 1.

| | Concentration | | Dry scratch | Wet scratch | Optical |
|---|---|---|---|---|---|
| | of AMEO | Gliding | resis- | resis- | appear- |
| # | [wt.-%] | agent | tance | tance | ance |
| C1 | 0.25 | Glasskote ® | 2 | 3 | 1 |
| | | SC 100 | | | |
| C2 | 0.5 | Glasskote ® | 2 | 3 | 1 |
| | | SC 100 | | | |

Both, the dry and the wet scratch resistance were inferior to those obtained when using the composition according to the invention.

### Comparative Application Example 2 (Two-Step Approach)

A solution of each of the comparative preparation example 1 to 3 was prepared by diluting it with water to the concentrations given in the following table (column headed “Amount of silane oligomer in the spraying solution [wt.-%]”). A dilution of the gliding agent was used (1 g Glasskote® SC 100 diluted with 99 g water). First, the bottles were treated with the spraying solution of the comparative preparation examples and then, with the dilution of the gliding agent. The results are given in the following table.

TABLE 5
Comparative examples.

| | | Amount of silane | Dry | Wet | |
|---|---|---|---|---|---|
| | Bottle | oligomer in | scratch | scratch | Optical |
| | temper- | the spraying | resis- | resis- | appear- |
| | ature | solution [wt.-%] | tance | tance | ance |
| CPE 1 | 130 | 0.25 | 1 | 3 | 1 |
| CPE 2 | 130 | 0.25 | 2 | 3 | 1 |
| CPE 3 | 130 | 0.25 | 1 | 3 | 1 |
| CPE 1 | 130 | 0.25 | 1 | 2 | 3 |
| CPE 2 | 130 | 0.25 | 2 | 2 | 3 |
| CPE 3 | 130 | 0.25 | 1 | 3 | 3 |

CPE = comparative preparation example

The results of the Application Examples show clearly that the composition according to the invention improves the scratch resistance of glass surfaces treated therewith compared to glass bottles treated by prior art methods. In particular, the wet scratch resistance was significantly enhanced. Surprisingly, some compositions showed enhanced results when stored for a longer period (#1 and #2).

In addition, the adhesion of the labels was excellent in case of the inventive examples and mostly better than those of the comparative examples (see the results given in table 2). It is also beneficial that no properties of the bottles were impaired such as their optical appearance or their (basic) strength.

Other embodiments of the present invention will be apparent to those skilled in the art from a consideration of this specification or practice of the invention disclosed herein. It is intended that the specification and examples be considered as exemplary only, with the true scope of the invention being defined by the following claims only.

1. A composition for treating at least one glass surface, comprising:
a) at least one bis-silyl compound comprising at least one building block according to the following formula (A): 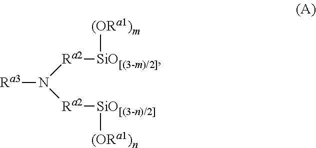
wherein
each R^{a1} is independently selected from the group consisting of hydrogen, alkyl group,
polyether group and aryl group,
each R^{a2} is independently an alkanediyl group,
R^{a3} is selected from the group consisting of hydrogen, alkyl group and aryl group,
m is an integer of from 0 to 3,
n is an integer of from 0 to 3, and
b) at least one gliding agent selected from the group consisting of wax, fatty acid and fatty acid ester.

2. The composition according to claim 1, wherein an amount of the at least one bis-silyl compound in the composition is from 0.001 to 10 weight %, based on the total composition.

3. The composition according to claim 1, wherein the at least one bis-silyl compound is an oligomer or a polymer.

4. The composition according to claim 1, wherein the at least one gliding agent is a wax.

5. The composition according to claim 4, wherein the at least one gliding agent a polyethylene wax.

6. The composition according to claim 1, wherein an amount of the at least one gliding agent is from 0.01 to 5 weight %, based on the composition.

7. The composition according to claim 1, whereon R^{a1} is selected from the group consisting of hydrogen and C1-C4-alkyl group, R^{a2} is a C2-C4-alkandiyl group and Ra3 is selected from the group consisting of hydrogen and C1-C4-alkyl group.

8. The composition according to claim 1, wherein the composition comprises water.

9. The composition according to claim 1, wherein the composition comprises at least one silane-based compound comprising at least one building block according to the following formula (I): 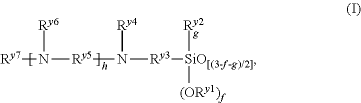
wherein
each R^{y1} is independently selected from the group consisting of hydrogen, alkyl group, polyether group and aryl group,
R^{y2} is an alkyl group,
R^{y3} is an alkanediyl group,
R^{y4} is selected from the group consisting of hydrogen, alkyl group, aryl group and alkaryl group,
each R^{y5} is independently an alkanediyl group,
R^{y6} is selected from the group consisting of hydrogen, alkyl group, aryl group and alkaryl group,
R^{y7} is selected from the group consisting of hydrogen and alkyl group,
f is 0 or 1,
g is 0, 1, or 2,
h is 0, 1, or 2,
with the proviso that the sum of f and g is from 0 to 2.

10. The composition according to claim 1, wherein a pH value of the composition is from 1 to 7.

11. The composition according to claim 1, further comprising:
at least one emulsifier;
optionally, at least one acid; and
water.

12. The composition according to claim 1, wherein R^{a3} is hydrogen.

13. A kit for preparing the composition of claim 1, comprising:
a part A comprising the at least one bis-silyl compound, and
a part B comprising the at least one gliding agent.

14. A method of preparing the composition of claim 1, the method comprising:
mixing the at least one bis-silyl compound, the at least one gliding agent and optionally, at least one emulsifier, optionally, at least one acid and optionally, water, in a vessel, thereby preparing the composition of claim 1.

15. A method for treating at least one glass surface of a substrate, the method comprising:
providing a substrate comprising at least one glass surface; and
treating the at least one glass surface with the composition of claim 1;
such that a treated glass surface is obtained.

16. A substrate, comprising:
at least one glass surface; and
at least one layer obtained by treating the at least one glass surface with the composition of claim 1.

17. The composition according to claim 1, wherein the amount of the at least one bis-silyl compound in the composition is from 0.01 to 4 weight %.

18. The composition according to claim 1, wherein the amount of the at least one bis-silyl compound in the composition is from 0.1 to 0.8 weight %.

19. The composition according to claim 1, wherein the at least one gliding agent is selected from the group consisting of amide wax, polyolefin wax and a copolymer thereof.

20. The composition according to claim 1, wherein an amount of the at least one gliding agent is from 0.1 to 2 weight %, based on the composition.
